(19) United States
(12) Patent Application Publication
(10) Pub. No.: US 2022/0184775 A1
(43) Pub. Date: Jun. 16, 2022

(54) METHOD FOR OPERATING A MACHINE

(71) Applicant: HOMAG Bohrsysteme GmbH, Herzebrock-Clarholz (DE)

(72) Inventor: Thomas BETTERMANN, Bielefeld (DE)

(21) Appl. No.: 17/598,202

(22) PCT Filed: Mar. 25, 2020
(86) PCT No.: PCT/EP2020/058352

§ 371 Date: Sep. 24, 2021

(30) Foreign Application Priority Data
Mar. 26, 2019 (DE) 10 2019 107 694.3

(51) Int. Cl. B24B 51/00; B24B 21/04; B24B 7/28

(52) U.S. Cl. CPC B24B 51/00; B24B 7/28; B24B 21/04

(57) ABSTRACT

The invention relates to a method for operating a machine, in particular a grinding machine, comprising the steps of: detecting a workpiece to be machined and setting various setting values of the machine, performing machining of the workpiece, detecting a first actual value and a second actual value during or after performance of the machining, wherein the first actual value is assigned a higher prioritization than the second actual value, comparing the first actual value with a first set value range and the second actual value with a second set value range, and changing the setting values of the machine such that the actual values meet the assigned target value range according to the prioritization.

### TECHNICAL FIELD

The method relates to a method for operating a machine, in particular a grinding machine. A grinding machine of this type is used, for example, for grinding plate-shaped workpieces which preferably comprise wood or wood-based materials. The invention furthermore relates to a machine.

### PRIOR ART

When grinding plate-shaped workpieces such as wooden boards or planks, manufacturers always strive to achieve a high-quality machining result within the manufacturing tolerances. The processing quality achieved during the grinding of such workpieces is also relevant for subsequent processing steps, for example when applying a coating, such as a varnish, to such a workpiece. For this purpose, it is necessary that a workpiece has a certain thickness, a plane surface and a specific surface quality after a grinding operation.

The setting of the grinding machine to perform the machining is done according to experience values in relation to the specific material to be machined as well as the dimensions of the workpieces. Moreover, the operator of the grinding machine can change settings of the grinding machine during machining of a large number of workpieces if the machining result is outside a tolerance.

The operator of the machine has various setting options to influence the machining result. For example, the contact pressure can be set to a certain level or the feed rate can be changed.

However, it has been shown that the setting of a specific target value, for example a specific workpiece thickness after performance of the machining, depends on a large number of influencing variables that mutually influence each other at least in part. In particular, the progress speed, the contact pressure, the speed of the grinding belt, the width as well as the thickness of the workpieces have an influence on the machining result.

Known from EP 2 815 844 A1 is a grinding machine comprising a grinding unit, a conveyor and a control device. The grinding machine further comprises a thickness determination device arranged downstream of the at least one grinding unit in the throughput direction, and with which an actual finished thickness of the workpiece machined by the at least one grinding unit can be determined. The control device is configured to compare the actual finished thickness of the workpiece with the nominal finished thickness and to control the operation of the at least one grinding unit in such a way that the actual finished thickness is adapted to the nominal finished thickness. Furthermore, a second thickness determination device can determine an actual base thickness of the unmachined workpiece.

For changing the machining result, reference is made in EP 2 815 844 A1 to the fact that a grinding machine is suitable to cooperate with a pressure beam and to control it based on the measurements of the actual base thicknesses and/or actual finished thicknesses.

Although the method described in EP 2 815 844 A1 has proven to be a practical solution, users are faced with increasing quality requirements. This is the point where the invention starts.

### SUBJECT MATTER OF THE INVENTION

An object of the invention is to provide a method for operating a machine, with which a high machining quality can be ensured over a wide range of workpieces.

The subject matter of claim 1 provides a corresponding method. Further preferred embodiments are specified in the dependent claims. The invention furthermore relates to a machine.

The method for operating a machine (for example, a grinding machine) comprises the steps of: detecting a workpiece to be machined and setting various setting values of the machine, performing machining of the workpiece, detecting a first actual value and a second actual value during or after performance of the machining, the first actual value being assigned a higher prioritization than the second actual value, comparing the first actual value with a first set value range and the second actual value with a second set value range, and changing the setting values of the machine such that the actual values meet the assigned target value range according to the prioritization. It is preferred that the steps are carried out in the aforementioned sequence.

The method according to the invention has the advantage that a high machining quality can be maintained when manufacturing a large number of pieces. It is also possible to significantly reduce the proportion of workpieces classified as rejects since the setting options can be continuously refined. Additionally or alternatively, it is possible to perform the setting of at least one setting value of the machine, in particular grinding machine, to some extent in a predictive manner.

“Surface structure” means a surface roughness determined by the number, the course, and the depth of the grooves or depressions present in a surface.

According to one embodiment, a neural network is used that performs optimization based on feedback from the system regarding achieved or unachieved target values, thereby inducing further development of the system. With such an algorithm, the high number of possibilities for influencing the machining quality can be taken into account.

According to one embodiment, it is provided that the first target value range is selected from: the thickness of the machined workpiece, the surface quality of the machined workpiece, and the flatness of a surface of the workpiece. Accordingly, a thickness of the machined workpiece, a surface quality of the machined workpiece, or a flatness of a surface of the workpiece is detected as a first actual value.

It is preferred that a camera or radar sensor is used to detect the surface structure of the workpiece to be machined and/or the machined workpiece. For example, it is possible to determine the workpiece dimension and the gloss level of the surface using a camera. A radar sensor can be used to determine the surface roughness.

In a further embodiment, it is provided that the thickness of the machined workpiece is detected by a tactile sensor or a non-contact sensor, in particular a laser sensor.

According to a further embodiment, it is provided that the second target value range is selected from: energy consumption of the machine, wear of a machining element, in particular wear of a grinding belt, suction rate for sucking off machining residues, feed rate.

For example, it can be provided that the energy consumption of the machine should be kept within a certain range to ensure an energy-efficient operation of the machine. The target value range of energy consumption can, for example, be based on external conditions such as current electricity prices which can fluctuate depending on the time of day.

The wear of a machining element, in particular wear of a grinding belt, can be selected in such a way that a change of the machining element takes place at a favorable time, for example after the production of a certain order. Less wear on the machining element can result in a longer production time per workpiece but in a higher quality machining result with a longer lifetime of the machining element.

A suction rate for sucking off machining residues influences the energy consumption of the machine as well as the quality of the machining result.

Achieving a specific feed rate results in a correspondingly higher or lower number of pieces per unit of time. Even though there is a general effort for a higher number of pieces per unit of time, the production speed can also be coordinated with regard to an overall process, for example to ensure a smooth material supply as well as a coordinated removal of the workpieces.

According to a further embodiment, it is provided that the setting values are selected from: a feed rate of the workpiece, a passage height, a cutting speed of a grinding belt, a contact pressure, a contact force, number, selection and/or combination of machining units in use, a feed value of a unit and a type of machining unit. It can thereby be provided that the setting values are changed by comparing the first actual value with a first target value range and the second actual value with a second target value range by taking into account the feed rate of the workpiece, the passage height, the workpiece width, the cutting speed of the grinding belt, the contact pressure, the ambient temperature and/or the air humidity.

In one embodiment, it is provided that the step of comparing and setting can be performed by a control device using artificial intelligence. Said artificial intelligence can be implemented by means of a neural network. After a learning phase, the neural network can make decisions to determine which setting values have to be changed to achieve the target value ranges.

The neural network is able to change various setting values influencing the overall result in such a way that the target value ranges are reached. As a specific example, a certain thickness of a workpiece or a certain surface quality can be selected as a first target value range, with a certain priority, a service life of the grinding belt or an energy consumption of the machine being further selected as a second target value range. According to the prioritization, the result of this is that as long as the first target value range is met, the system works to meet the second target value range to the best possible extent. If the first target value range is no longer met, the setting values are changed such that the first target value range is still met.

According to one embodiment, the machine is configured as a grinding machine. It is thereby preferred that the grinding machine comprises, as a grinding device, a belt grinding device, a disc brush, a grinding roller, a brush roller, a transverse belt grinding unit, a fine grinding unit or a combination thereof.

It can thereby be provided that various grinding devices of the grinding machine are controlled by respectively setting at least one setting value of the respective grinding unit. In this manner, the machining result can be acted upon through different measures.

In one embodiment, it is provided that the changed setting values are stored in a storage device, with it being preferred that the actual values as well as the corresponding target values are also stored in the storage device. The changed values are thus available for further machining operations.

The invention furthermore relates to a machine, in particular a grinding machine. The machine can be configured to implement, in each case individually or in combination, previously described features of the method and/or features of the dependent method claims.

### BRIEF DESCRIPTION OF THE DRAWING

FIG. 1 shows a schematic structure of a wide belt grinding machine configured to carry out the method according to the invention.

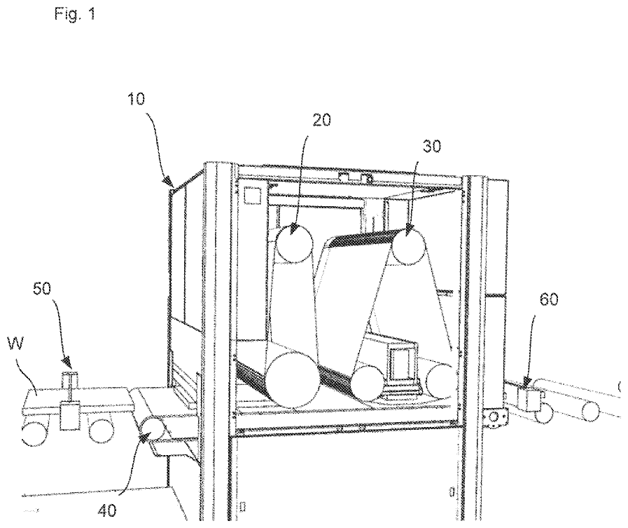

### DETAILED DESCRIPTION OF THE PREFERRED EMBODIMENTS

Preferred embodiments of the method according to the invention will be described by means of the enclosed FIGURE. Although the embodiments described below are to be understood purely as examples, and are not restrictive, features of the embodiments can also be individually used to specify the invention. Moreover, embodiments can be combined with one another in order to form new embodiments of the invention.

The embodiment example is directed at a grinding process to vividly describe the invention. However, the invention is not limited thereto.

A grinding machine according to the embodiment comprises a housing 10 accommodating a first grinding device 20 and a second grinding device 30. The grinding machine further comprises a feed mechanism 40 that moves a workpiece W through the housing 10 of the grinding machine.

The workpieces machined with the grinding machine are preferably formed plate-shaped. In particular, these are workpieces made of wood or wood-based materials that are used, for example, in the furniture or components industry. As a specific example, these can, for example, be furniture fronts; shelves; ceiling, floor or wall panels, or the like.

A first thickness measurement sensor 50 is provided in the inlet area of the housing 10. The thickness measurement sensor 50 is configured to determine a workpiece thickness before the workpiece W is machined by the grinding machine. The thickness measurement sensor 50 can be a tactile sensor or a non-contact sensor with which the thickness of the workpiece W to be machined is detected.

A second thickness measurement sensor 60, which can be configured in a similar manner as the first thickness measurement sensor 50, is disposed in the outlet area of the housing 10. The second thickness measurement sensor 60 is configured to determine a workpiece thickness after the workpiece W has passed through the grinding machine.

In addition, the grinding machine is equipped with further sensors with which the parameters mentioned below can, individually or in combination, be determined.

The quality of the grinding belt during processing can be determined by means of a grinding belt sensor. The condition of the granulation, and thus the degree of wear, can thereby be determined. For example, a grinding belt sensor can be a radar sensor with which the grinding belt is continuously monitored and evaluated accordingly. In the case of the radar sensor, conclusions can be drawn from the detected intensity of the radiation reflected at the grinding belt as regards the granulation or roughness of the grinding belt, and according to another application, it can be detected when the grain size is reduced due to wear of the grinding belt.

As an alternative to a grinding belt sensor, the quality of the grinding belt can also be calculated on the basis of the determined engagement time of the grinding belt and the determined service life. For this purpose, the duration of each engagement on a workpiece is detected, in particular by detection of the respective workpiece length in the transport direction.

The passage height between the conveyor mechanism and the grinding belt can be detected by means of a grinding pad position sensor and/or a position sensor for detecting the position of a grinding roller.

Furthermore, the feed rate of the conveyor mechanism 40 is detected using a sensor. Alternatively or additionally, the feed rate can be determined based on the control commands used to drive the conveying mechanism 40.

By means of a tactile or optical width measurement sensor in the inlet area of the housing, the component dimension is determined in a direction perpendicular to the throughfeed direction. Specifically, it is determined whether the workpiece being fed to the grinding devices 20, 30 is wide or narrow.

The orthogonal force by which the grinding belt is pressed against the workpiece is determined by means of a contact pressure sensor.

One or more temperature sensors detect the ambient temperature as well as the temperature of the workpiece which heats up during machining.

Furthermore, the air humidity in the machining area can be determined by means of an air humidity sensor.

The machine can be provided with a sensor with which the suction rate is determined. This is done, for example, by detecting the number of revolutions of a fan.

The machine can further be provided with a sensor which determines the energy consumption of the machine.

As a further sensor, a first optical sensor can be provided in the inlet area and a second optical sensor in the outlet area of the housing 10, and therefore the surface structure, and thus the surface quality, can be determined before and after the grinding process by means of the optical sensors.

The grinding machine according to the embodiment comprises a control device configured to control the operation of the grinding machine. The aforementioned sensors are connected to the control device and accordingly transmit information continuously or at specific intervals, in particular regarding the quality of the grinding belt, the passage height, the feed rate, the component dimensions, the cutting speed of the grinding belt or belts, the difference between the initial thickness of the workpiece and the actual thickness after grinding, the contact pressure, the temperature or temperatures and the humidity.

In addition, the control device manages and/or monitors the number and combination of the grinding devices. In the embodiment example, the grinding device 20 is a so-called contact roller unit. The roller of the contact roller unit, which is lower in the vertical direction, presses the grinding belt against a workpiece W moved by the conveyor mechanism 40.

In the grinding device 30, three rollers are provided for moving the grinding belt, the rollers facing the workpiece being a calibration roller and a deflection roller. A grinding pad is provided between the calibration roller and the deflection roller, which presses the grinding belt against the workpiece to be ground.

The information acquired by various sensors is combined in the control device of the grinding machine and evaluated for controlling the operation of the grinding machine. Thus, different information can be correlated and coordinated with each other.

The control device includes a module that performs calculations using an algorithm based on artificial intelligence. This means that the values detected by the sensors and the instructions derived therefrom are continuously detected and revised, with a workpiece thickness and a surface structure (and thus the surface quality) of the workpiece W being used as target value ranges.

The aforementioned artificial intelligence can be implemented using a neural network. After a learning phase, the neural network can make decisions to determine which setting values have to be changed to achieve the target value ranges. The neural network is able to change various setting values influencing the overall result in such a way that the target value ranges are achieved.

The target value ranges are prioritized relative to each other. A first target value range can thus be assigned a higher prioritization than a second target value range. Hence, the machine is operated in such a way that the first actual value is in the first target value range. If this is ensured, setting values are further changed, if necessary, such that the second actual value is in the second target value range.

As a specific example, a certain thickness of a workpiece or a certain surface quality can be selected as a first target value range. In this context, it is also possible to define different first target value ranges, for example a workpiece thickness, a surface quality and a flatness of the surface.

A high feed rate can be selected as a second target value range.

According to the prioritization, the result of this is that as long as the first target value range is met, the system works to meet the second target value range to the best possible extent. If the first target value range is no longer met, the setting values are changed such that the first target value range is still met.

The control device thereby decides which parameters influencing the grinding result should be changed in order to achieve the highest possible quality (low tolerance of the workpiece thickness as well as a specific target value of a surface structure) with simultaneously high productivity or low energy consumption (as examples of a second target value range).

During operation of a grinding machine, pressure segments in the pressure beam of the grinding machine are activated after a workpiece is detected. It is detected whether a pressure segment, with which a grinding belt is pressed against the workpiece surface, presses onto the workpiece over the entire surface or only part thereof. Accordingly, a higher or lower force is applied to the pressure segments to achieve a specific contact pressure.

In this context, it can be provided that a detection of the contact pressure is performed. In combination with a detection of the surface of the ground workpiece, the machining results can be optimized. In this context, it can be determined that a certain surface is achieved as a target value range in a certain pressure range.

For workpieces of similar dimensions, an increase in the contact pressure can possibly lead to higher wear of the grinding belts of the grinding devices 20, 30 which in turn causes shorter maintenance intervals for replacing the grinding belt. The control device can therefore decide to combine a certain contact pressure with a favorable feed rate such that a high machining quality is ensured with low wear of the grinding belts.

1. A method for operating a machine, the method comprising the steps of:
detecting a workpiece to be machined and setting a plurality of setting values of the machine;
performing machining of the workpiece;
detecting a first actual value and a second actual value during or after performance of the machining, wherein the first actual value is assigned to a first priority, the second actual value is assigned to a second priority, and the first priority is a higher priority than the second priority;
comparing the first actual value with a first target value range and the second actual value with a second target value range; and
changing the plurality of setting values of the machine so that the first and second actual values meet the assigned first and second target value ranges, respectively, according to the respective first and second priorities.

2. The method according to claim 1, wherein the first target value range is selected from: a thickness of the machined workpiece a surface quality of the machined workpiece, and a flatness of a surface of the workpiece.

3. The method according to claim 2, wherein a camera or a radar sensor is used to detect the workpiece to be machined or the machined workpiece.

4. The method according to claim 2, wherein the thickness of the machined workpiece is detected by a tactile sensor or a laser sensor.

5. The method according to claim 1, wherein the second target value range is selected from: energy consumption of the machine, wear of a grinding belt, a suction rate, or a feed rate.

6. The method according to claim 1,
wherein the plurality of setting values are selected from:
a feed rate of the workpiece, a passage height, a cutting speed of a grinding belt, a contact pressure, a contact force, a number, a selection or a combination of machining aggregates in use, a feed value of an aggregate, a type of a machining unit, and
wherein the plurality of setting values are changed by comparing the first actual value with the first target value range and the second actual value with the second target value range, based on the feed rate of the workpiece, the passage height, a workpiece width, the cutting speed of the grinding belt, the contact pressure, the contact force, an ambient temperature or air humidity.

7. The method according to claim 1, wherein the comparing is performed by a control device using artificial intelligence.

8. The method according to claim 1, wherein the machine is configured as a grinding machine, wherein the grinding machine comprises a grinding device, and wherein the grinding device comprises a belt grinding device, a disc brush, a grinding roller, a brush roller, a transverse belt grinding unit, a grinding unit or a combination thereof.

9. The method according to claim 8, wherein the grinding machine comprises a plurality of grinding devices, wherein each of the plurality of grinding devices comprises the grinding device, and wherein components of the respective grinding device of the plurality of grinding devices is controlled by respectively setting at least one setting value of the respective grinding unit.

10. The method according to claim 1, wherein the changed plurality of setting values are stored in a storage device, and wherein the first and second actual values as well as the corresponding first and second target value ranges are stored in the storage device.

11. A machine, comprising:
one or more grinding devices configured to perform machining of a workpiece;
a first detection device configured to detect a first actual value of the workpiece after or during performance of machining of the workpiece;
a second detection device configured to detect a second actual value of the workpiece after or during performance of the machining; and
a control device configured to:
compare the first actual value with a first target value range and the second actual value with a second target value range, and
change a plurality of setting values of the machine to enable the first and second actual values to meet the assigned first and second target value ranges, respectively, according to the respective first and second priorities,
wherein the first actual value is assigned to a first priority, the second actual value is assigned to a second priority, and the first priority is a higher priority than the second priority.

12. The machine according to claim 11, wherein:
the first detection device is configured to measure a first thickness of the workpiece before the workpiece passes through the one or more grinding devices;
the second detection device is configured to measure a second thickness of the workpiece after the workpiece passes through the one or more grinding devices;
the first actual value is the first thickness of the workpiece; and
the second actual value is the second thickness of the workpiece.

13. The method according to claim 2, wherein a camera or a radar sensor is used to detect the workpiece to be machined and the machined workpiece.

14. The method according to claim 3, wherein the thickness of the machined workpiece is detected by a tactile sensor or a laser sensor.
